(19) United States
(12) Patent Application Publication
(10) Pub. No.: US 2010/0013925 A1
(43) Pub. Date: Jan. 21, 2010

(54) PORTAL PROXIMATE DIGITAL COMMUNICATIONS DEVICE

(76) Inventors: Daniel B. Fowler, Rocky River, OH (US); Suzette M. Fowler, Rocky River, OH (US)

Correspondence Address: James C. Scott;Roetzel & Andress, Suite 900, 1375 East Ninth Street, Cleveland, OH, 44114, US

(21) Appl. No.: 12/505,821

(22) Filed: Jul. 20, 2009

Related U.S. Application Data
(60) Provisional application No. 61/081,757, filed on Jul. 18, 2008.

(51) Int. Cl. H04N 7/18; G06F 3/041

(52) U.S. Cl. 348/143; 348/164; 345/87; 345/173; 348/E07.085

(57) ABSTRACT

A device which incorporates a digital camera and video display monitor that displays, in real time, live video of activities occurring in the proximity of the device and as a digital signage electronic display that is capable of receiving and displaying video information, advertising and other messages transmitted from a network. The device is typically mounted on or proximate to a door of a residential dwelling or a hotel guestroom. A group of devices can be managed locally or remotely over a network. The multi-functional display is capable of displaying live video of the area located on the exterior side of the door and/or video advertising that may or may not be specifically directed to a specific group of devices. The device includes, among other things, a miniature camera and camera housing located on the exterior of the door and a video display and motion sensor located on the interior of the door and controlled by a microprocessor.

### RELATED APPLICATIONS

This application claims priority to U.S. Provisional Application No. 61/081,757 filed on Jul. 18, 2008.

### FIELD OF THE INVENTION

The present invention is in the general field of digital communications, digital signage and building and property information technology electronics.

### BACKGROUND OF THE INVENTION

Digital communications is the transmission of a sequence of digital messages or a digitized analog signal. Digital signs are electronic displays that are installed in locations to entertain, inform or advertise to persons within visual proximity to the display. It is a form of information presentation in which content and messages are displayed on digital signs, typically with the goal of delivering targeted messages to specific locations at specific times. The major benefits of dynamic digital advertising and messaging over traditional static signs are that the content can be changed remotely and electronically, video streams can be displayed and digital displays can adapt to the context and audience and even be interactive. Digital signage displays are often controlled and populated via connectivity to information technology networks.

### SUMMARY OF THE INVENTION

The portal proximate digital communications device of the present invention and related disclosure contains a camera housing attached to a door, a digital camera and a lens piece in the camera housing, the lens piece providing a light path from an exterior of the door to the digital camera. The device further includes a display housing spaced from and not connected to the camera housing, the display housing having a chassis configured to fit against an interior side of the door and hold a display device, a power source and circuitry for generating and displaying an image. A microprocessor, contained upon a printed circuit board located within the display housing, integrates all computer components and other electronic system functions. An infrared motion sensor, also located within the display housing and mounted on the interior side of the door, activates the display upon the approach of a potential viewer. Each device is connected over a wireless network connection to at least one distribution server which is in turn connected via a wired or wireless network to at least one content management server. Each content management server is connected via a wired or wireless network to at least one content designer workstation where property advertising, third party advertising, informational and property management system derived content is prepared for distribution through the digital signage network to at least one portal proximate digital communications device.

### DESCRIPTION OF THE DRAWINGS

FIG. 1 is a schematic diagram of the primary electronic components of the Portal Proximate Digital Communications Device of the present invention.

FIG. 2 is diagram of a potential network topology illustration the internet communications links for multiple installations of the Portal Proximate Digital Communications Device.

FIG. 3 is an exploded view of the main body of the Portal Proximate Digital Communications Device.

FIG. 4 is a cross-section of the Portal Proximate Digital Communications Device as installed in a door.

### DETAILED DESCRIPTION OF PREFERRED AND ALTERNATE EMBODIMENTS

The Portal Proximate Digital Communications Device (hereinafter referred to as “PPDCD”) of the present invention and related disclosure is a multi-function display and capture system mounted on or proximate to the entryway or doorway of building structures. The PPDCD includes all features of the Video Door Viewer as described in International Patent Application Serial No. PCT/US07/000430 filed on Jan. 1, 2007, which is incorporated herein by reference. The Video Door Viewer is a device used for viewing areas exterior to a door in the manner of a tube-type peephole. Further, the Video Door Viewer is an integrated electronic system which uses a liquid crystal display (LCD) screen and a miniature electronic, digital camera, such as a Charged Coupled Device (CCD) or a Complementary Mctal Oxide Semiconductor (CMOS) type camera, and a lens piece with a pinhole lens to deliver images. The PPDCD integrates the Digital Signage and Video Viewer functionalities within one unit. The PPDCD and the Digital Door Viewer use the same display panel to display live video of the area located on the exterior side of the door and/or digital signage content.

The PPDCD functions as both a digital camera and video display monitor that displays, in real time, live video of activities occurring in the proximity of the PPDCD and as a digital signage electronic display node that is capable or receiving and displaying video information, advertising and other messages transmitted from a network. The PPDCD defines a space or a “dwell zone” location (i.e., a residential or hotel guestroom door) where occupants focus attention during entry and exit from the room and provides the opportunity for occupants to watch a video display and potentially become educated, informed and/or influenced by the displayed content. One of the unique features of the PPDCD is the ability to “screen spot.” The PPDCD display position on the guestroom door provides optimal screen spotting by displaying messages in a highly effective and previously unexploited viewing area while still blending into the ambient space and design environment. The PPDCD can be placed at any position and thereby provides for optimal screen spotting by displaying informational content where it can easily, safely and securely viewed, as well as serviced, replaced and/or updated without difficulty and at minimal expense.

The main physical components of the PPDCD are an LCD panel or other visual display platform; an infrared motion sensor; and an embedded microcontroller (microprocessor) with associated electronic circuitry to generate, receive, transmit, process and display video, graphic images or text on a screen display or other digital or analog information originating from a variety of local and wide area networks and internet sources. The PPDCD further includes additional hardware, software and firmware components, which will be discussed in detail below.

### Hardware

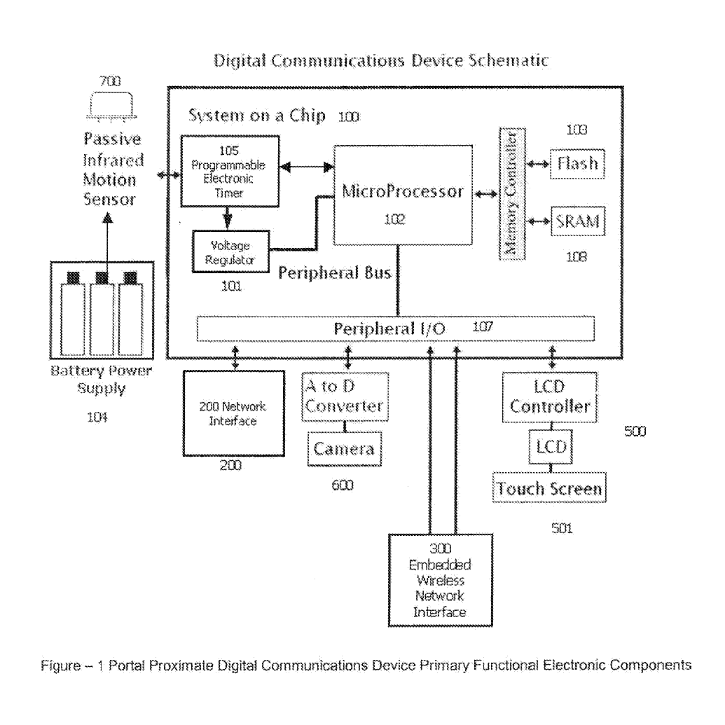

As shown in FIG. 1, one of the main hardware components that make up the PPDCD is a system-on-a-chip (SoC) or system on chip (SOC) 100 that operates as an embedded microprocessor that integrates all computer components and other electronic system functions into a single integrated circuit. It contains digital, analog, mixed-signal and radio frequency processing capabilities. A fully programmable SoC or SOC provides overall control of the PPDCD and enables operation and management of all device functions including Internet Protocol for communicating data across a packet-switched network using the TCP/IP suite of protocols, wireless and wired communication to a computer or communications network 200, and the display of information. The microprocessor may operate at clock frequencies as low as 32 kHz, enabling lower power consumption (milliwatts or microwatts). Power consumption of the processor while sleeping (CPU clock and most peripherals off) may be just nanowatts, making the processor well suited for long lasting battery power supply. The CPU contained within the microprocessor can range from a 4-bit to a 64-bit processor. In one embodiment, the microprocessor operates absent a CPU fan or any moving disk platters. The microprocessor may also include the following features: discrete input and output bits, allowing for control or detection of the logic state of an individual package pin; serial input/output such as serial ports or Universal Asynchronous Receiver/Transmitters (UART); a serial communication interface such as I2C, Serial Peripheral Interface 107; a controller for the system to interconnect with peripheral devices; peripherals such as timers, event counters, Pulse-Width Modulation (PWM) generators and watchdog; Random Access Memory (RAM) for data storage 108; Read-Only Memory (ROM), Erasable Programmable Read-Only Memory (EPROM), Electrically Erasable Programmable Read-Only Memory (EEPROM) or Flash memory for program and operating parameter storage 103; a clock generator, such as an oscillator for a quartz timing crystal, a resonator or RC circuit; an analog-to-digital converter; in-circuit programming and debugging support; a controller for a CCD or CMOS chip; and an Ethernet interface.

The PPDCD also includes a liquid crystal display (LCD) 500 (also part of the Video Door Viewer), which is an electronically modulated optical device shaped into a thin, flat panel made up of any number of color pixels filled with liquid crystals and arrayed in front of a light source or backlight. The LCD is battery-powered and requires very small amounts of electric power. The LCD may additionally be touch-enabled or capable of reacting to the touch of a user for activation of interactive media.

A Pyroelectric Infrared Sensor (PIR sensor) or PIR-based motion detector 700 is also a component of the PPDCD. The motion detector may also be referred to as A Passive Infrared Detector or PID. The PIR-based sensor is mounted on a printed circuit board containing the necessary electronics required to interpret the signals from the pyroelectric sensor chip and which functions as a power on and off switch for the entire embedded microprocessor system. The complete PIR assembly is contained within the PPDCD housing and mounted in a location on the LCD 500, on the interior side of the portal, where the sensor can view the area to be monitored for the approach of occupants or viewers. As used herein, the term “portal” means any entrance to a room or space or any means of access to an enclosed space including, but not limited to, rooms in buildings. The PIR output activates a relay capable of closing the power circuit and thereby activating the electronic components of the system. Upon approach of a potential viewer, the display will become activated. A programmable electronic timing device 105 may be programmed via the microprocessor 102 to set the exact amount of time that the power circuit will be closed and delivering power to the electronic components. The instructions to set the power-up time may be transmitted via the device network interface from the content management server.

Additional hardware components include a printed circuit board (PCB) used to mechanically support and electrically connect the electronic components of the device using conductive pathways laminated onto a non-conductive substrate; a voltage regulator 101 designed to automatically maintain a constant voltage level for operation of the SOC, PIR, LCD, camera and other components; a touch-screen device that can detect the presence and location of a touch within the display area of the PPDCD and that enables a user to interact with what is displayed directly on the screen 501; and a battery power supply 104 composed of one or more common, off-the-shelf battery types such as “AA”, “AAA” or “9V”, which functions as the main power supply for the entire unit.

### Software

The PPDCD of the present invention and related disclosure includes software for the operation of the microprocessor and other hardware components. In addition to the basic operating system class of software, the PPDCD also includes application specific software designed to provide precise control of the delivery and display of network-delivered information as well as the local area video image data output from the embedded camera. Digital signage content delivered by the PPDCD has three primary models which are: out-of-home/ad-driven; brand driven; or informational. In most cases, the content delivered by the invention will be a blend featuring some aspects of all three. THE PPDCD will have the capability of locally running advertisement proof-of-play software to log the number of times that advertisements are displayed.

The PPDCD will allow for segmentation of the screen into various regions. The LCD display screen can be broken into multiple segments for various purposes. A portion of the screen will normally always display the video output from the camera mounted in the door, so that the room occupant can see what or who is outside the door. Another portion of the screen may show local weather conditions while yet another display window runs advertising content and special offers. The system will be capable of switching from split screen to full screen when required. The PPDCD is capable of delivering layered content, in which bits of content can be stacked on top of one another. For example, all or portions of the display could be built with two layers—a text layer and a graphics layer. The graphics layer could stay the same in all device units within the same property, with just the text changing locally, reducing the amount of rendering needed. The PPDCD software is built around a central concept of internet connectivity, making it possible to perform content updates and modifications from anywhere.

Software used in conjunction with the PPDCD may also include: machine-level instructions for digital camera video output processing; an instruction set that speeds up JPEG image compression; a Real Time Operating System (RTOS) to allow the microprocessor to respond in a micro-second to local environmental or remote network generated events; an RTOS design that implements time-sharing scheduling with priority driven pre-emptive scheduling; and an embedded RTOS such as OS-9, pSOS, VelOSity, QNX, VxWorks and VRTX.

### Network

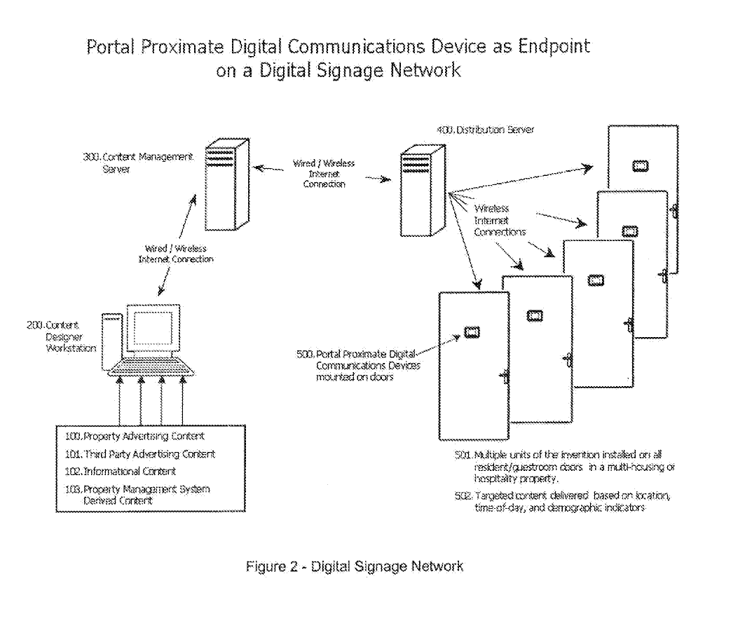

The PPDCD of the present invention is a display device or an endpoint of a digital signage network. FIG. 2 contains a schematic drawing of one possible network design. The digital signage network includes a group of centrally managed and addressable PPDCDs 500 that present content to a targeted audience 501. Using appropriate digital signage software, these unit embodiments of the invention can be controlled locally or can be managed over IP, allowing content, such as property advertising 100, third-party advertising 101, information 102, or information derived from other data systems 103, to be created and modified remotely at one or more content design workstations 200. To manage a network, a management server 300 is typically required. The management server 300 can be located anywhere, so long as it is connected to the digital signage network. New content is managed and organized at the management server 300 level. A distribution server 400 manages the routing of content to individual PPDCDs 500. The actual content is stored and played on the PPDCDs 500. Network control software is employed to provide content and network management capabilities including scheduling the delivery of location-specific playlists and across multiple device units and locations. The network control software is enabled to deliver standard digital media formats without conversion to other formats, including Flash™, QuickTime™, WindowsMedia™, MPEG-1, MPEG-2, DivX, Images, URLs, High Definition Video and others.

The networkability of the PPDCD enables the system to function as a node in a digital communications, advertising and signage network. The PPDCD display can be utilized to create conversations with specific groups including, but not limited to, residential occupants and hotel guests, by providing relevant information, wayfinding, meeting schedules and branding or promotional messages. THE PPDCD provides a previously unexploited screen spot for advertising programs enabling the host property to earn revenue by selling time on the digital signage network addressing individual residential or guestrooms to outside advertisers.

The PPDCDs function as endpoints, interaction points, connection points or interface points in computer-networks and allow-for uni-casting of specific information and messages to a single destination such as a residence or hotel room. Arrays of PPDCD nodes in multi-residential or lodging room facilities can also deliver broadcast information to all locations or multicast information to selected groups of PPDCDs within the network. THE PPDCD network enables the creation of an “occupant graph”, which is a pattern of nodes representing residents and/or guests of PPDCD-equipped properties and the links among them. The PPDCD nodes enable participating properties to create networks around specific interests and create their own custom marketing network for a particular topic or need, catering to dynamically specified audiences. PPDCDs can deliver extremely targeted and compelling messages to residents or hotel guests at the room level. As an addressable unit capable of delivering paid advertising messages, the PPDCD is a profit center which is treated as a distinct entity enabling revenues and expenses to be determined so that the individual location profitability can be measured.

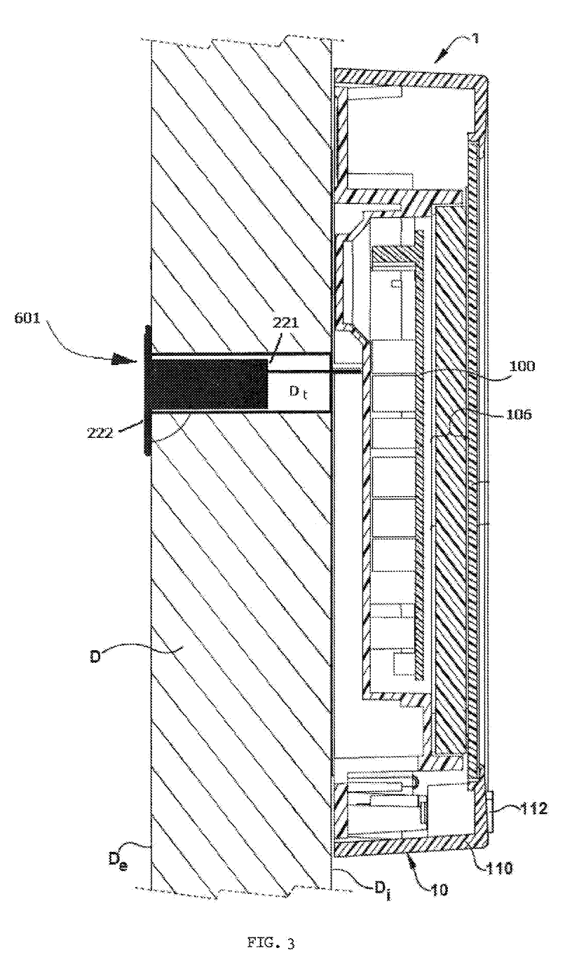

FIG. 3 shows a cross-sectional view of the PPDCD of the present invention, generally indicated at 1, as installed on a mounting structure D. The display housing 10 is mounted to or otherwise attached to an interior side Dᵢ of a door or other mounting structure D and the camera housing 221 is mounted to an exterior side Dₑ of the mounting structure D. A through-hole Dₜ is formed within the door structure D for passage of an electrical connection between the camera housing 221 and the display housing 10. The camera housing 221 is spaced from and not mechanically connected to the display housing 10. The through-hole Dₜ is solely for the purpose of passage of a wire connection between the camera housing 221 and the digital sign housing 10. A cover 110 extends about the perimeter of the digital sign component chassis 101 and encapsulates and frames the digital sign components. The passive infrared motion detector switch 112 is mounted within the cover 110. When activated by the motion sensor 112, the circuitry powers the camera 601 that in turn generates a video image of the exterior area of the mounting structure D that is displayed on the LCD display 106. When activated, the circuitry also powers the circuit board 100 to receive and display information, content, graphics, advertising or other data directed to the digital sign component from one or more remote network connections.

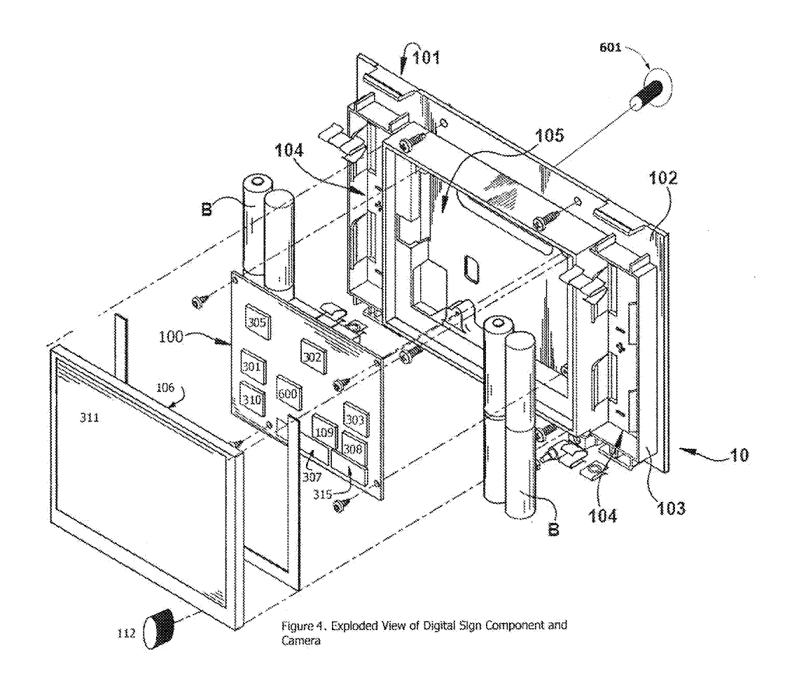

FIG. 4 shows an exploded view of the PPDCD. The chassis 101 includes a mounting frame 102 and wall structures 103 which project from the mounting frame 102. The wall structures 103 define one or more battery compartments 104 for holding batteries B in electrical connection with the device for powering the micro processor camera and display circuitry. A central cavity 105 is dimensioned to receive a display 106, such as for example, an LCD display, along with the circuit board 100 and associated circuitry mounted opposite to the display side of the display 106 and thus encapsulated within the central cavity 105 of the chassis 101. Flush external surfaces of the mounting frame 102 are positioned against an interior side of a mounting structure such as a door and attached thereto by fasteners.

To carry out the door viewer function of the PPDCD, the device contains ultra-mini CMOS or other chip-type color digital camera 601. The camera 601 is installed within the mounting structure such as a door as shown in FIG. 3. The camera housing is designed to fit substantially within a through-hole Dₜ in a mounting structure D such as a door, and substantially flush with the exterior surface Dₑ of the mounting structure D. The camera 601 has a generally cylindrical body which, as shown in FIG. 3, fits within a cylindrical hole or through-hole Dₜ in the mounting structure with a flange 222 configured to fit flush against the exterior surface Dₑ of the mounting structure D.

A motherboard, or printed circuit board (PCB) 100, is used to mechanically support and electrically connect the electronic components of the device that support an embedded microprocessor 302 and that integrate all computer components and other computer system functions. The PCB 100 contains all components needed to function as a fully programmable computer. Contained within the motherboard are: a fully programmable microprocessor 302; LP-enabled circuitry 310; an analog-to-digital converter 600; ROM, EPROM, EEPROM or Flash memory 303; RAM 308; a programmable electronic timing device 305; a voltage regulator; a serial peripheral interface 307; and an embedded wireless network interface 315.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

1. A portal proximate digital communications device comprising:
a camera housing adapted to attach to a portal, a digital camera and a lens piece in the camera housing, the lens piece providing a light path from an exterior of the portal to the digital camera;
a display housing spaced from and not connected to the camera housing, the display housing having a chassis configured to fit against an interior side of the portal and hold a display device, a power source and circuitry for generating and displaying an image;
an embedded microprocessor, contained on a printed circuit board within the display housing with electronic circuitry for generating, receiving, transmitting, processing and displaying video, graphic images or text, on the display and originating from a variety of local and wide area networks and internet sources;
an infrared motion sensor located within the display housing and mounted on the interior side of the portal;
digital signage software;
network control software; and
a power supply,
wherein the PPDCD is connectable to at least one content designer workstation for preparing digital content which is operatively connected to at least one content management server which is operatively connected to at least one distribution server.

2. The portal proximate digital communications device of claim 1, wherein the display device is a liquid crystal display (LCD) screen.

3. The portal proximate digital communications device of claim 1, wherein the microprocessor is a system-on-a-chip (SoC).

4. The portal proximate digital communications device of claim 3, wherein the SoC is fully programmable.

5. The portal proximate digital communications device of claim 1 further comprising a touch-screen capable of detecting the presence and location of a touch within the display area.

6. The portal proximate digital communications device of claim 1, further comprising a programmable electronic timing device.

7. The portal proximate digital communications device of claim 1, wherein the display screen may be segmented into various viewing regions.

8. The portal proximate digital communications device of claim 1, wherein the device is capable of delivering layered content.

9. The portal proximate digital communications device of claim 1 further comprising a Real-Time Operating System (RTOS).

10. The portal proximate digital communications device of claim 1, wherein the device is mounted to a hotel guestroom door.

11. The portal proximate digital communications device of claim 1, wherein the device is mounted to a residential door.

12. The portal proximate digital communications device of claim 1, wherein the microprocessor is designed for a 45 nm CMOS process.

13. The portal proximate digital communications device of claim 1, wherein the infrared motion sensor is a pyroelectric infrared sensor.

14. A portal proximate digital communications device for displaying images across a portal and for displaying network-delivered information comprising:
a camera housing;
a lens piece and a digital camera within the camera housing, the camera housing adapted to be mounted proximate to an exterior surface of a portal;
a display housing spaced from and not connected to the camera housing;
a display, power source and image generation circuitry within the display housing adapted to be mounted proximate to a side of the portal opposite the camera housing;
power control for controlling power to the image generation circuitry for display of an image obtained by the digital camera on the display;
a microprocessor and software for displaying images detected by the digital camera and for establishing a connection to a network and receiving digital signage data via the network; and
an infrared motion sensor;

15. The portal proximate digital communications device of claim 14, wherein the display device is a liquid crystal display (LCD) screen.

16. The portal proximate digital communications device of claim 14, wherein the microprocessor is a system-on-a-chip (SoC).

17. The portal proximate digital communications device of claim 16, wherein the SoC is fully programmable.

18. The portal proximate digital communications device of claim 14 further comprising a touch-screen capable of detecting the presence and location of a touch within the display area.

19. The portal proximate digital communications device of claim 14, further comprising a programmable electronic timing device.

20. The portal proximate digital communications device of claim 14, wherein the display screen may be segmented into various viewing regions.

21. The portal proximate digital communications device of claim 14, wherein the device is capable of delivering layered content.

22. The portal proximate digital communications device of claim 14 further comprising a Real-Time Operating System (RTOS).

23. The portal proximate digital communications device of claim 1, wherein the device is mounted to a hotel guestroom door.

24. The portal proximate digital communications device of claim 14, wherein the device is mounted to a residential door.

25. The portal proximate digital communications device of claim 14, wherein the microprocessor is designed for a 45 nm CMOS process.

26. The portal proximate digital communications device of claim 14, wherein the infrared motion sensor is a pyroelectric infrared sensor.
